(19) United States
(12) Patent Application Publication
(10) Pub. No.: US 2006/0117626 A1
(43) Pub. Date: Jun. 8, 2006

(54) Suspended greeting card display

(76) Inventor: Kui Eng Cheng, North Point (HK)

Correspondence Address: Kirschstein, Ottinger, Israel & Schiffmiller, P.C., 489 Fifth Avenue, New York, NY, 10017-6105, US

(21) Appl. No.: 11/007,389

(22) Filed: Dec. 8, 2004

(51) Int. Cl. G09F 7/22

(52) U.S. Cl. 40/617

(57) ABSTRACT

A greeting card is suspended for multiple freedoms of movement from an overhead support mountable on different supporting surfaces.

### BACKGROUND OF THE INVENTION

1. Field of the Invention

The present invention is generally directed to greeting cards and, more particularly to a suspended greeting card display having freedom of movement especially in response to air currents.

2. Description of the Related Art

Greeting cards bearing a message of greeting, congratulation or other sentiment are usually sent or given on a special occasion or holiday, or sometimes for no reason at all. The cards are typically imprinted with a commercial message, or are blank to allow a customized message to be written thereon. A typical card structure has at least one panel, and preferably a plurality of panels which, when opened, reveal either sequential parts of the message, or the entire message. The panels are generally formed of a paper sheet stock which is stiff enough to self-support a two-panel greeting card when placed, on edge, on a horizontal support surface, such as a desk, shelf, or mantel, in a partially open position.

As advantageous as greeting cards are for conveying social expression messages, the cards are not well suited for continuous display. For example, the partially opened cards are prone to falling down flat on the horizontal support surface, especially in response to air current, thereby defeating their display function. Also, the known card structures cannot be supported from a vertical or inclined support surface, such as a refrigerator, a computer monitor, a wall, a door, etc.

### SUMMARY OF THE INVENTION

### OBJECTS OF THE INVENTION

Accordingly, it is a general object of this invention to offer new and attractive vehicles for conveying social expression messages.

More particularly, it is an object of the present invention to provide a greeting card which takes on aspects of a gift item as well.

Still another object of the present invention is to provide a suspended greeting card having multiple freedoms of movement.

It is yet another object of the present invention to enable a greeting card to be suspended from both vertical and horizontal support surfaces.

### FEATURES OF THE INVENTION

In keeping with the above objects and others which will become apparent hereinafter, one feature of the present invention resides, briefly stated, in a suspended greeting card display including a folded card having sheet material panels for bearing a message, and a support for suspending the card for free movement, preferably from a horizontal or a vertical support surface. The support includes an arm having an overhead fastener above the card, and a string connected between the overhead fastener and the card for hanging the card for free movement relative to the support.

In one embodiment, the support includes a base that rests on a horizontal support surface, and the arm includes an upright post portion fixedly mounted on the base, and a crossbeam portion extending from the post portion to the overhead fastener. The post and crossbeam portions are preferably integral parts of a rigid wire. In another embodiment, the base is a suction cup for attachment to a vertical support surface.

In either embodiment, the overhead fastener is a loop on which one end of the string is hooked. The card has a hole through which another end of the string is connected. The card panels may be blank for receipt of a written message, or imprinted with a commercial message.

In accordance with this invention, the card is supported from a variety of horizontal, vertical and inclined support surfaces. If exposed to air currents, the display of this invention does not fall over as in the prior art discussed above, but instead, moves with multiple freedoms of movement, thereby creating an animated display.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a closed card display according to one embodiment of this invention;

FIG. 2 is a perspective view of the display of FIG. 1, when opened;

FIG. 3 is a perspective view of a closed card display according to another embodiment of this invention; and

FIG. 4 is a perspective view of the display of FIG. 3, when opened.

### DETAILED DESCRIPTION OF THE PREFERRED EMBODIMENTS

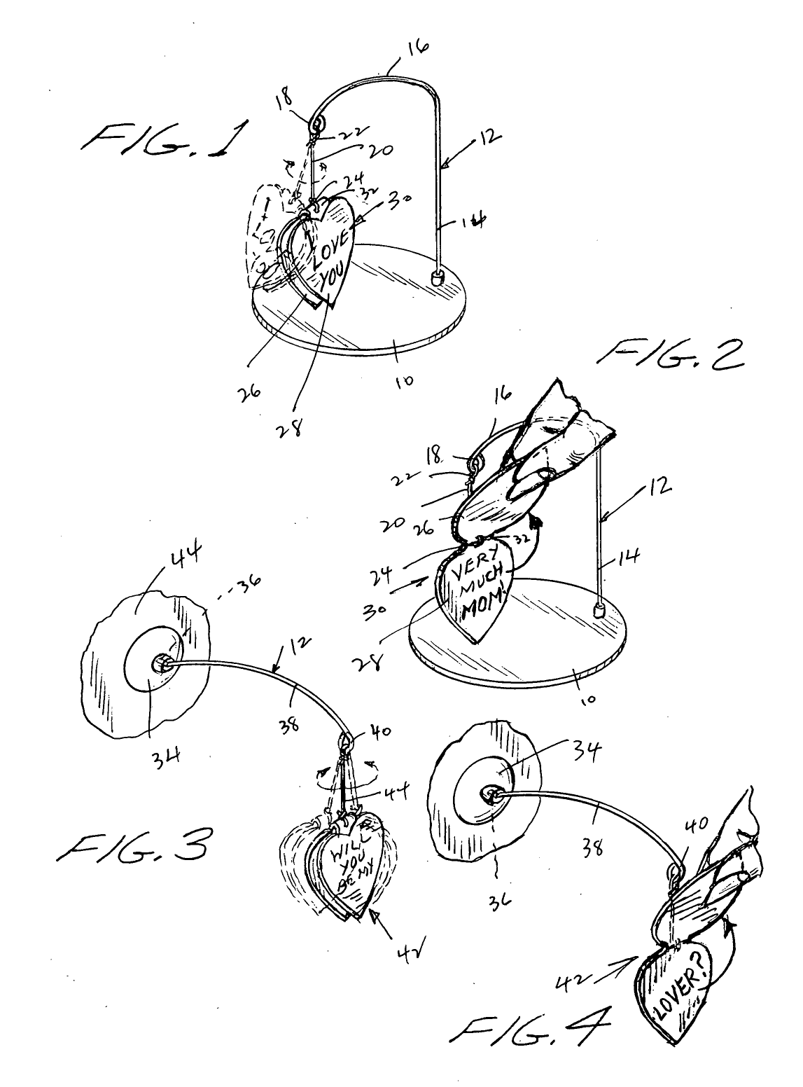

FIGS. 1-2 depict one embodiment of a suspended greeting card display suitable for being supported on a horizontal support surface, such as a desk, shelf, and table, and FIGS. 3-4 depict another embodiment of the display suitable for being supported on a vertical or inclined support surface, such as a refrigerator, computer monitor, door, wall, etc.

As shown in FIGS. 1-2, a stationary base 10 rests on the horizontal support surface, and a rigid wire 12 is fixedly mounted on the base 10. The rigid wire 12 includes an upright post portion 14 and an integral arm or crossbeam portion 16, preferably arch-shaped. The crossbeam portion 16 has a free end formed as a loop which serves as an overhead fastener 18 from which one end 22 of a string 20 is hooked. An opposite end 24 of the string 20 is connected to a folded card 30 to suspend the card 30 for free movement relative to the base 10, as demonstrated by the phantom lines in FIG. 1.

The folded card 30 has a pair of sheet material panels 26, 28, preferably of a stiff paper stock for bearing a message. The panels are foldable about a score line or hinge 32 to open the card, as shown in FIG. 2, to reveal the message. The card has a hole, preferably through the hinge 32, through which the opposite end 24 of the string 20 is routed. A preprinted commercial message can be imprinted on one panel, or both panels, of the card, or the panels can be left blank for receipt of a customized, handwritten message.

In FIG. 3, the base is a suction cup 34, and the rigid wire 12 includes a post portion 36 fixedly mounted to the cup 34 and an arch-shaped crossbeam portion 38 which, as before, terminates in a loop-shaped overhead fastener 40 from which a folded card 42 is suspended by a string 44 for freedom of movement, as indicated by the phantom lines in FIG. 3. FIG. 4 depicts the opened card of FIG. 3 to reveal a closing part of the message applied to the card. The suction cup is detachably secured to a supporting surface 44 by applying a suction force thereto.

In use, a greeting card recipient is presented with the display of FIG. 1 for placement on a horizontal support surface, or with the display of FIG. 3 for placement on a vertical or inclined support surface. The greeting card is always in view, even when subjected to air currents which only serve to enhance and animate the display.

Modifications of the illustrated embodiments include making the post portion 14 of FIG. 1 out of two telescoping parts to enable the height of the card relative to the base to be adjusted. The card itself can be ornamented with decorations, and can even support additional sheet material items suspended by strings from the card, thereby resembling a mobile sculpture. The post portions 14, 36 need not be fixed to their bases, but can also be rotatably mounted therein.

It will be understood that each of the elements described above, or two or more together, also may find a useful application in other types of constructions differing from the types described above.

While the invention has been illustrated and described as embodied in a suspended greeting card display, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A suspended greeting card display, comprising:
a) a folded card having sheet material panels for bearing a message; and
b) a support for suspending the card for free movement, including an arm having an overhead fastener above the card, and an elongated string connected between the overhead fastener and the card for hanging the card for free movement relative to the support.

2. The card display of claim 1, wherein the panels are folded along a hinge, and wherein at least one of the panels has a surface on which the message is applied.

3. The card display of claim 1, wherein the surface is a writing surface on which the message is written.

4. The card display of claim 1, wherein the support includes a base for supporting the display on a generally horizontal support surface.

5. The card display of claim 4, wherein the arm includes an upright post portion mounted on the base, and a crossbeam portion extending from the post portion to the overhead fastener.

6. The card display of claim 5, wherein the crossbeam portion is shaped as an arch.

7. The card display of claim 5, wherein the post and crossbeam portions are integral parts of a rigid wire.

8. The card display of claim 1, wherein the overhead fastener is a loop on which one end of the string is hooked.

9. The card display of claim 1, wherein the card has a hole through which one end of the string is connected.

10. The card display of claim 1, wherein the support includes a base for supporting the display on a generally vertical support surface.

11. The card display of claim 10, wherein the base is a suction cup.
